(19) United States
(12) Patent Application Publication
(10) Pub. No.: US 2016/0118019 A1
(43) Pub. Date: Apr. 28, 2016

(54) IMAGE PROCESSING DEVICE AND IMAGE PROCESSING METHOD

(71) Applicants: Kabushiki Kaisha Toshiba, Tokyo (JP); Toshiba Lifestyle Products & Services Corporation, Tokyo (JP)

(72) Inventor: Toshiyuki NAMIOKA, Kumagaya Saitama (JP)

(21) Appl. No.: 14/680,875

(22) Filed: Apr. 7, 2015

(30) Foreign Application Priority Data
Oct. 23, 2014 (JP) 2014-216699

(51) Int. Cl. G09G 5/02; H04N 7/01; H04N 9/64; H04N 9/69; H04N 5/44; H04N 5/445

(52) U.S. Cl. CPC G09G 5/02; H04N 5/4401; H04N 5/44513; H04N 9/64; H04N 9/69; H04N 7/0117; G09G 2340/06

(57) ABSTRACT

An image processing device has a communication module which performs information communication with a color gamut information providing device for providing color gamut information concerning a color gamut of video data of a received broadcast program, a controller which acquires the color gamut information of the video data from the color gamut information providing device through the communication module, and an image quality corrector which restores the color gamut of the video data of the broadcast program, based on the color gamut information acquired by the controller.

### CROSS REFERENCE TO RELATED APPLICATIONS

This application is based upon and claims the benefit of priority from the prior Japanese Patent Application No. 2014-216699, filed on Oct. 23, 2014, the entire contents of which are incorporated herein by reference.

### FIELD

Embodiments of the present invention relate to an image processing device and an image processing method.

### BACKGROUND

In recent years, development of 4K/8K television, which is ultra high definition television (UHDTV) based on next-generation broadcasting standards, has been advanced. An extremely wide color gamut is determined for the UHDTV based on the BT.2020 standard defined by the International Telecommunication Union (ITU), and the 4K/8K television is expected to display more vivid images than ever. However, in the present circumstances, color gamut supported by most of broadcast devices (e.g., video cameras) and recorded video content is narrower than BT.2020 color gamut. Thus, even if UHDTV broadcasting based on the BT.2020 standard is started, there is a strong possibility that video data having a narrow color gamut is transmitted through airwaves. In this case, the 4K/8K television cannot easily judge whether the color gamut of the video data included in the airwaves is narrow or not, which means that the video data is displayed as it is with a narrow color gamut and consequently cannot be displayed vividly.

Techniques for restoring color gamut have been put to practical use to restore image data having a narrow color gamut to a vivid image closer to the original image. This color gamut restoration can be achieved if the color gamut of video data to be received is previously known. However, as stated above, if the video data is received through the airwaves based on the BT.2020 standard covering a wide color gamut, it may be possible that the video data is interpreted by the 4K/8K television as having a wide color gamut and displayed as it is without restoring the color gamut thereof.

As stated above, when broadcasting based on BT.2020 is started, it may be possible that the function of restoring color gamut provided to the 4K/8K television is not effectively utilized and consequently the video cannot be displayed vividly.

### BRIEF DESCRIPTION OF THE DRAWINGS

FIG. 1 is a block diagram of an image processing device according to a first embodiment.

FIG. 2 is a diagram comparing BT.2020 color gamut and BT.709 color gamut in the CIE 1931 chromaticity diagram.

FIG. 3 is a flow chart when viewing a real-time program according to the first embodiment.

FIG. 4 is a flow chart when viewing a reproduced program according to the first embodiment.

FIG. 5 is a block diagram of the image processing device according to a second embodiment.

FIG. 6 is a block diagram of the image processing device according to a third embodiment.

### DETAILED DESCRIPTION

An image processing device according to an embodiment has a communication module which performs information communication with a color gamut information providing device for providing color gamut information concerning a color gamut of video data of a received broadcast program, a controller which acquires the color gamut information of the video data from the color gamut information providing device through the communication module, and an image quality corrector which restores the color gamut of the video data of the broadcast program, based on the color gamut information acquired by the controller.

Embodiments will now be explained with reference to the accompanying drawings.

### First Embodiment

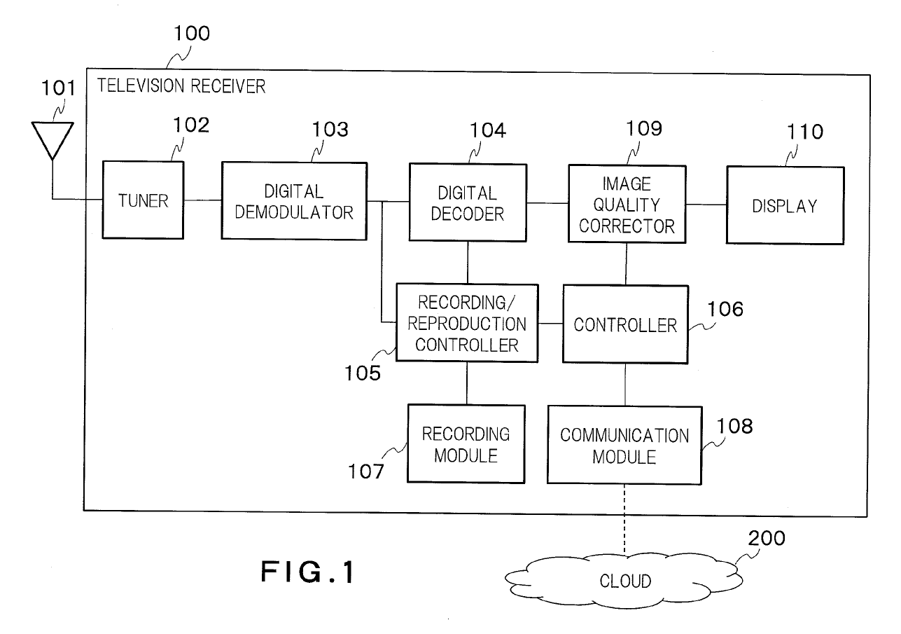

FIG. 1 is a block diagram showing a schematic configuration of an image processing device according to a first embodiment. The image processing device according to the first embodiment is a television receiver 100 having a function of recording video data.

This television receiver 100 has an antenna 101, a tuner 102, a digital demodulator 103, a digital decoder 104, a recording/reproduction controller 105, a controller 106, a recording module 107, a communication module 108, an image quality corrector 109, and a display 110. Further, the television receiver 100 of FIG. 1 communicates with a cloud 200 which offers a service of providing color gamut information concerning the color gamut of video-related data (video data).

The antenna 101 receives a broadcast signal of digital television broadcasting. The broadcast signal may be received through, e.g., UHDTV broadcasting based on BT.2020 or through another broadcasting based on different broadcasting standards. Further, the broadcasting system may be arbitrarily selected from terrestrial broadcasting, BS (broadcasting satellite) broadcasting, CS (communication satellite) broadcasting, etc. Note that the present embodiment can be applied when receiving a broadcast signal from a communication network such as cable television and the Internet. In this case, the antenna 101 may be omitted and the television receiver 100 of FIG. 1 may have a set-top box. The tuner 102 extracts the broadcast signal of a specific selected channel from the broadcast signals received by the antenna 101. Note that it is possible to provide a mode for receiving and recording broadcast signals of all channels.

The digital demodulator 103 outputs a digital stream by performing demodulations such as TC-8PSK and OFDM or error correction (e.g., deinterleaving) on the broadcast signal selected by the tuner 102. The digital stream has not only video data but also sound-related data and attribute information including program information concerning airtime, title, etc.

The digital decoder 104 performs decoding processing etc. on the digital stream to generate decoded video data. Note that not only video data but also sound-related data may be extracted.

The recording/reproduction controller 105 extracts the attribute information from the digital stream, and transmits it to the controller 106. In accordance with the instructions by the controller 106, the recording/reproduction controller 105 performs control to record the digital stream in the recording module 107 and to reproduce the digital stream recorded in the recording module 107.

The controller 106 transmits the program information included in the attribute information to the cloud 200 through the communication module 108, and acquires the color gamut information corresponding thereto from the cloud (color gamut information providing device) 200 through the communication module 108.

The cloud 200 is in fact a server connected to a communication network, for example. The cloud 200 provides various services through the communication network. The cloud 200 according to the present embodiment offers a service of providing color gamut information of video data of a program.

The service of the cloud 200 may be provided by a broadcasting station or by a private company, a public institution, or an individual, instead of the broadcasting station.

In the present embodiment, the color gamut information is acquired from the cloud 200 as an example. The provider of the color gamut information should not be limited to the cloud 200, and any type of color gamut information providing device may be used as long as it can provide color gamut information of the video data of a received broadcast program. As stated above, the color gamut information is provided by a color gamut information providing device connected to the television receiver 100 of FIG. 1 through wired or wireless communication. In the example explained below, the color gamut information is provided by a color gamut information providing device connected anywhere on the communication network, and this color gamut information providing device is referred to as “cloud 200.”

The color gamut information is provided for each program correspondingly. One program may include a plurality of pieces of color gamut information. For example, video data of one program may be separated by predetermined separators such as time stamps to set color gamut information of each divided section. For example, each of the opening data, main data, commercial data, etc. of a program is generally separated by time stamps and often has a different color gamut. Accordingly, if color gamut information is set for each time stamp, by referring to the color gamut information, it is possible to display each scene in the program with optimum color gamut by adjusting the color gamut restoring method on each time stamp.

The data format of the color gamut information acquired from the cloud 200 is not particularly questioned. For example, when there are a plurality of pieces of color gamut information corresponding to the video data of one program, the pieces of color gamut information may be provided by the cloud 200 as one organized file or as a plurality of files.

It is desirable to acquire the color gamut information prior to the start time of a program to be viewed. The reason is that if the color gamut information is acquired after the program starts, the video data cannot be viewed with an optimum color gamut before the color gamut information is acquired to perform the color gamut restoring process. There are several methods to acquire the color gamut information before the program starts. For example, when selecting a channel, information concerning programs to be broadcasted in the future is acquired from broadcast waves etc. in order to previously acquire, from the cloud 200, the color gamut information concerning the programs to be broadcasted on the selected channel. Instead, the color gamut information concerning all programs for one day may be acquired from the cloud 200 at the fixed time in each day. Further, the color gamut information acquired before the program starts may be recorded in the recording module 107 etc. in order to read the color gamut information from the recording module 107 when the program starts.

Based on the acquired color gamut information, the controller 106 generates an image quality correction control signal as parameters used by the image quality corrector 109 when restoring the color gamut. This image quality correction control signal is a signal obtained by relating the acquired color gamut information to a time stamp of the program, for example. When the received video data has BT.2020 color gamut, the controller 106 instructs the image quality corrector 109 not to restore the color gamut. This is because there is no need to restore the color gamut when the video data originally has BT.2020 color gamut.

In addition, the controller 106 instructs the recording/reproduction controller 105 to record and reproduce a digital stream. Since the color gamut should be restored also when reproducing the video data recorded in the recording module 107, the controller 106 acquires color gamut information when reproducing the video data. The color gamut information may be acquired from the cloud 200 each time the video data is reproduced. Instead, the color gamut information may be acquired from the cloud 200 and recorded in the recording module 107 etc. only when the video data is reproduced for the first time, and the color gamut information may be read out from the recording module 107 when the video data is reproduced for the second time or later.

Further, when recording the digital stream in the recording module 107, the color gamut information acquired from the cloud 200 may be recorded in association with the digital stream. In this case, the video data can be reproduced only by reading the recorded color gamut information from the recording module 107, which leads to quick reproduction.

The recording module 107 records the digital stream of a broadcast program based on the instructions by the recording/reproduction controller 105. The recording module 107 may further record the attribute information extracted by the recording/reproduction controller 105, the color gamut information acquired from the cloud 200, and other data. The recording module 107 may be as an arbitrary storage. The arbitrary storage may include not only a disk device but also an arbitrary memory device such as a RAM and a NAND-type flash memory. Further, the recording module 107 may include both of a volatile memory and a nonvolatile memory.

The communication module 108 performs information communication with the cloud 200.

The image quality corrector 109 restores the color gamut of the video data based on the image quality correction control signal, and outputs a video signal. The color gamut restoring process to be performed is a process for restoring the colors of the original image by estimating the colors from a color signal which is compressed into a narrow color gamut and transmitted through broadcast waves. The color gamut restoring process may be performed together with scaling, brightness correction, color correction, contrast adjustment, color signal adjustment, resolution conversion, etc. The signal to be outputted is a signal which can be received by the display 110, such as an RGB signal and a YCbCr signal.

The image quality corrector 109 may start restoring the color gamut immediately after receiving the image quality correction control signal or after the scene has switched. For example, when a channel is switched in real-time viewing, a little time lag occurs before acquiring the color gamut information to generate the image quality correction control signal. In this case, the color gamut may be restored at the point when the current scene switches, instead of performing the restoration promptly.

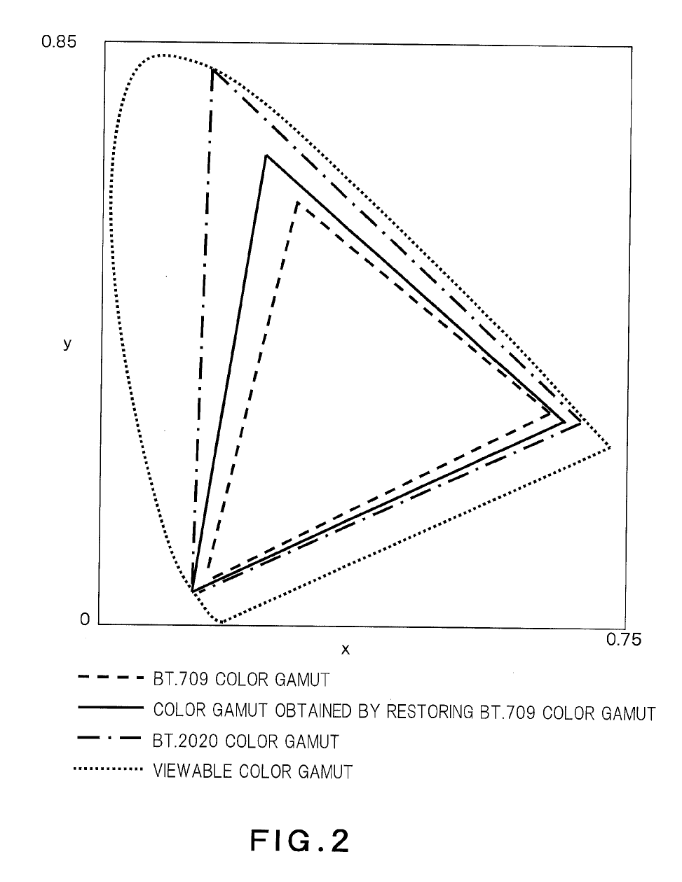

FIG. 2 is a chromaticity diagram of light on a two-dimensional plane defined by the X-axis and Y-axis, the chromaticity diagram being determined by the International Commission on Illumination (CIE) in 1931. Each of the X-axis and Y-axis shows chromaticity. In the X-axis, the ratio of red increases as the numerical value becomes larger, and the ratio of blue increases as the numerical value becomes smaller. In the Y-axis, the ratio of green increases as the numerical value becomes larger, and the ratio of blue increases as the numerical value becomes smaller. The horseshoe-shaped range enclosed by a dotted line shows a viewable color gamut. The range enclosed by a broken line shows BT.709 color gamut, and the range enclosed by a dashed-dotted line shows BT.2020 color gamut.

When video data has BT.709 color gamut, restoring the color gamut makes it possible to extend the displayable color gamut to the range enclosed by a solid line. Accordingly, the video after its color gamut is restored is displayed more vividly than the video before its color gamut is restored. When transmitted video data has BT.2020 color gamut, which is wider than color gamut obtained by restoring BT.709 color gamut, the video data is displayed more vividly than the video has restored BT.709 color gamut theoretically even when the video data is displayed as it is. However, actually, it is not unusual to transmit video data having BT.709 color gamut by using broadcast waves based on BT.2020 color gamut. In this case, the video data, if its color gamut is not restored, is displayed with a narrow color gamut enclosed by a broken line in FIG. 2. Accordingly, in the present embodiment, even when receiving broadcast waves based on BT.2020 color gamut, the image quality corrector 109 restores the color gamut of the received video data if the color gamut is narrow.

In the example explained above, video data having BT.709 color gamut is transmitted using broadcast waves based on BT.2020 color gamut. A similar process as in this example can be applied to the case of transmitting video data having a color gamut narrower than BT.2020 color gamut, such as a color gamut determined based on e.g. DCI-P3 widely used in movie making etc., to appropriately restore the color gamut.

The image quality corrector 109 corrects the image quality each time the video data is reproduced. Recording the data having a restored color gamut in the recording module 107 eliminates the need to restore the color gamut each time the video data is reproduced. However, it is undesirable since an encoder must be provided separately to encode the data having the restored color gamut and to store it in the recording module, which complicates the internal configuration of the image processing device and increases the cost thereof.

The display 110 is a video display device which displays video from the video signal outputted from the image quality corrector 109. As the video display device, a flat display device such as an organic EL panel and a wide color gamut liquid crystal panel may be used, but another type of display device may be used instead.

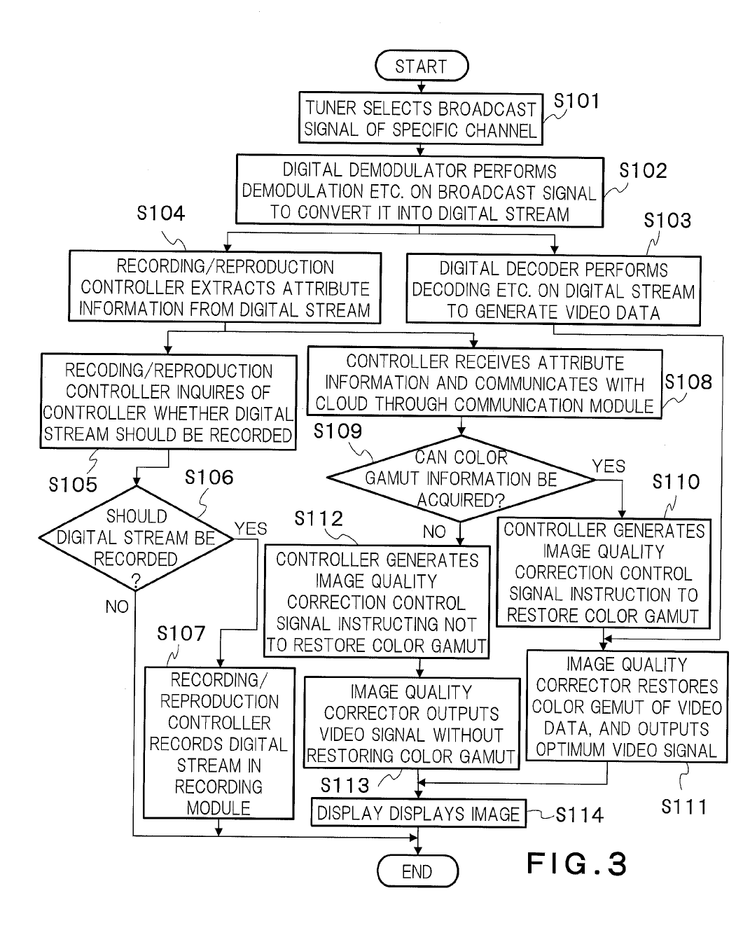

FIG. 3 is a flow chart showing the steps of image processing when viewing a real-time program in the present embodiment.

The tuner 102 receives a selection by the user, and selects the broadcast signal of a specific channel (S101). This broadcast signal is transmitted to the digital demodulator 103.

The digital demodulator 103 performs demodulation etc. on the broadcast signal to convert it into a digital stream (S102). The digital stream is transmitted to the digital decoder 104 and recording/reproduction controller 105.

The digital decoder 104 performs decoding such as descrambling on the receive digital stream to generate video data (S103).

On the other hand, the recording/reproduction controller 105 extracts attribute information from the digital stream, and transmits it to the controller 106 (S104). Further, the recording/reproduction controller 105 inquires of the controller 106 whether the digital stream should be recorded (S105), and if necessary (YES at S106), the recording/reproduction controller 105 records the digital stream in the recording module 107 (S107).

Based on the program information included in the received attribute information, the controller 106 communicates with the cloud 200 providing color gamut information through the communication module 108, to acquire color gamut information of the video data (S108). If the color gamut information can be acquired (YES at S109), the controller 106 generates an image quality correction control signal instructing to restore the color gamut, and transmits it to the image quality corrector 109 (S110). The image quality corrector 109 restores the color gamut of the video data based on the image quality correction control signal, and outputs an optimum video signal (S111). If the color gamut information cannot be acquired or there is no corresponding color gamut information (NO at S109), the controller 106 generates an image quality correction control signal instructing not to restore the color gamut, and transmits it to the image quality corrector 109 (S112). The image quality corrector 109 outputs the video signal as it is without restoring the color gamut of the video signal, depending on the image quality correction control signal (S113).

The display 110 receives the outputted video signal, and displays the video (S113). In this way, image processing performed when viewing a real-time program is completed.

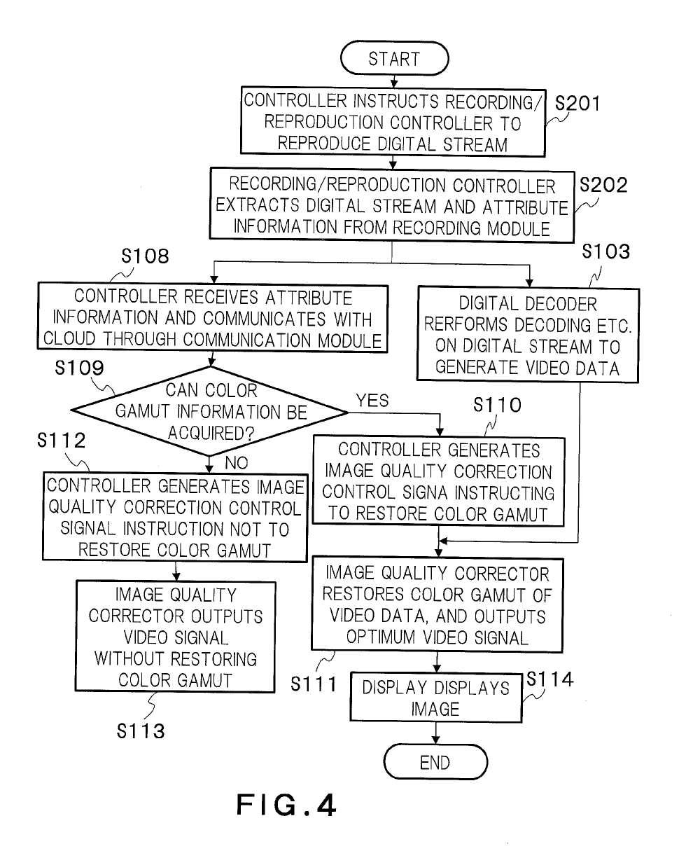

FIG. 4 is a flow chart showing the steps of image processing when reproducing a digital stream recorded in the recording module in the present embodiment.

The controller 106 instructs the recording/reproduction controller 105 to reproduce a digital stream recorded in the recording module 107 (S201).

The recording/reproduction controller 105 extracts the digital stream from the recording module 107. Further, the recording/reproduction controller 105 extracts attribute information from the digital stream. The extracted digital stream and attribute information are transmitted to the digital decoder 104 and controller 106 respectively (S202).

The steps following Step S202 are similar to those performed when viewing a real-time program, and thus the explanation thereof will be omitted. In this way, image processing performed when viewing a reproduced program is completed.

As stated above, in the first embodiment, when receiving broadcast waves, color gamut information of the video data included in the received broadcast waves is acquired from the cloud 200 to restore the color gamut of the video data as needed using the acquired color gamut information. Thus, when video data having a narrow color gamut is transmitted using broadcast waves based on a wide color gamut such as BT.2020, the color gamut of the video data can be restored in an optimum way, which makes it possible to display the video data with vivid colors taking full advantage of the performance of the display 110. Particularly, in the present embodiment, there is no need to incorporate color gamut information into broadcast waves since the color gamut information is acquired from the cloud 200, which makes it possible to restore the color gamut without changing the transmission system of the broadcast waves. The cloud 200, which can arbitrarily change the settings of the color gamut information to be provided thereby, can provide such color gamut information as differing depending on each time stamp, by which the color gamut of each scene in one program can be restored using a different technique. Further, when color gamut information concerning broadcast programs is acquired before those start in accordance with a program guide, each broadcast program can be displayed with an optimum color gamut from the opening thereof.

The color gamut of the video data included in the received broadcast waves can be guessed by analyzing the bit pattern of the video data. However, performing such analysis in a short time requires increasing the processing capacity of the image processing device. On the other hand, in a system which acquires color gamut information from the cloud 200 as in the present embodiment, extremely high processing capacity is not required for the image processing device itself, which makes it possible to restore the color gamut in an optimum way and at low cost.

### Second Embodiment

A second embodiment to be explained below relates to an image processing device which has no recording module and is dedicated on real-time viewing only.

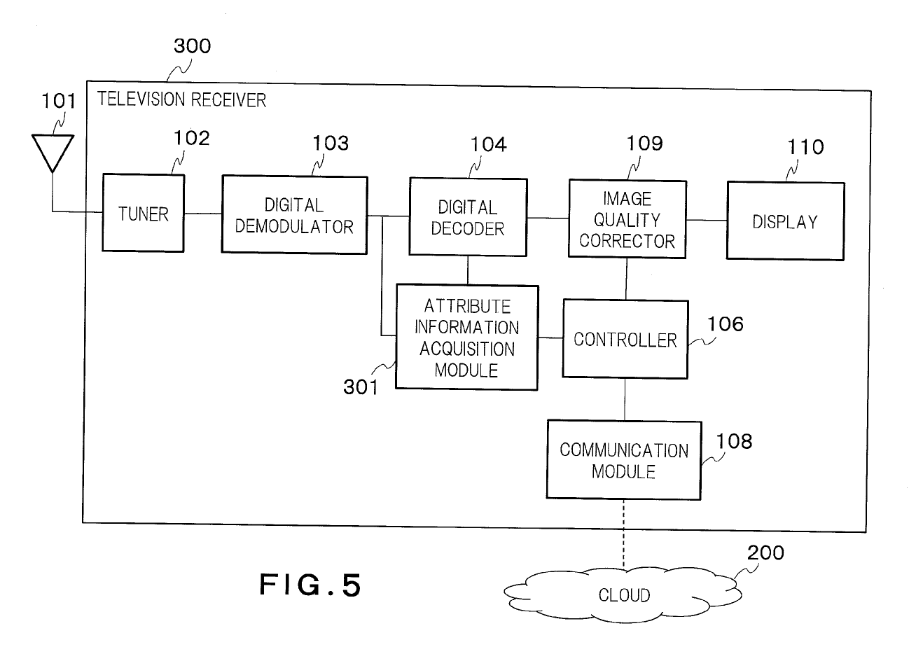

FIG. 5 is a block diagram showing a schematic configuration of the image processing device according to the second embodiment.

A television receiver 300, which is the image processing device according to the second embodiment, has no recording module and is dedicated on real-time viewing only. The television receiver 300 has the antenna 101, the tuner 102, the digital demodulator 103, the digital decoder 104, the controller 106, the communication module 108, the image quality corrector 109, the display 110, and an attribute information acquisition module 301.

The attribute information acquisition module 301 is provided instead of the recording/reproduction controller 105 of FIG. 1. The attribute information acquisition module 301 extracts attribute information from a digital stream, and transmits it to the controller 106.

The image processing device of FIG. 5 is similar to the image processing device of FIG. 1 except that the image processing device of FIG. 5 has no recording/reproduction functions, and thus detailed explanation thereof will be omitted.

In the second embodiment, when compared to the first embodiment, the recording module is omitted and the attribute information acquisition module 301, which does not have the function of controlling recording and reproduction, is provided instead of the recording/reproduction controller 105, which makes it possible to simplify the internal configuration of the image processing device and reduce production cost compared to the first embodiment.

### Third Embodiment

A third embodiment to be explained below relates to an image processing device having recording/reproduction functions.

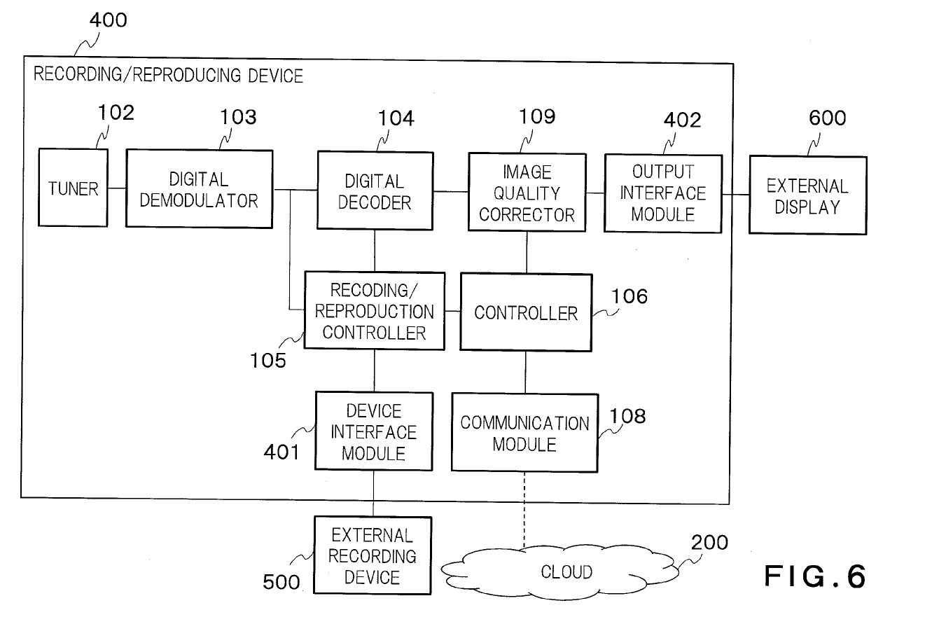

FIG. 6 is a block diagram showing a schematic configuration of the image processing device according to the third embodiment.

The image processing device according to the third embodiment is a recording/reproducing device having recording/reproduction functions only, which is, i.e., a recorder. This recording/reproducing device 400 has the tuner 102, the digital demodulator 103, the digital decoder 104, the recording/reproduction controller 105, the controller 106, a device interface module 401, the communication module 108, the image quality corrector 109, and an output interface module 402.

A recording/reproducing device 400 in the present embodiment is similarly to FIG. 1 except that it has no display. Further, the tuner 102 and digital demodulator 103 can be omitted depending on the situation. It is also possible to connect the recording/reproducing device 400 of FIG. 6 to a television device to receive a digital stream demodulated by the television device by the recording/reproducing device 400 and record the digital stream in the recording module 107.

The device interface module 401 transmits/receives data to/from an external recording device 500 such as USB and SDIO. The external recording device 500 is a magnetic recording device such as HDD, a semiconductor storage device such as SSD and USB memory, or any one of various optical recording devices etc. Note that the recording/reproducing device 400 may have a recording device therein.

The video signal outputted from the recording/reproducing device 400 is transmitted to an external display 600 through the output interface module 402. It is desirable that the output interface module 402 is an interface such as HDMI (registered trademark) and Display port for outputting a digital signal, but another type of interface may be used instead.

Similarly to the first and second embodiments, the recording/reproducing device 400 of FIG. 6 also acquires, from the cloud 200, color gamut information corresponding to program information, and the image quality corrector 109 restores the color gamut using the color gamut information.

As stated above, even when the image processing device has no display function, it is possible to appropriately restore the color gamut in the image processing device by acquiring color gamut information from the cloud 200, similarly to the first and second embodiments.

While certain embodiments have been described, these embodiments have been presented by way of example only, and are not intended to limit the scope of the inventions. Indeed, the novel methods and systems described herein may be embodied in a variety of other forms; furthermore, various omissions, substitutions and changes in the form of the methods and systems described herein may be made without departing from the spirit of the inventions. The accompanying claims and their equivalents are intended to cover such forms or modifications as would fall within the scope and spirit of the inventions.

1. An image processing device comprising:
a communication module to perform information communication with a color gamut information providing device for providing color gamut information of video data of a received broadcast program;
a controller to acquire the color gamut information of the video data from the color gamut information providing device through the communication module; and
an image quality corrector to restore color gamut of the video data of the broadcast program, based on the color gamut information acquired by the controller.

2. The image processing device of claim 1, further comprising:
an attribute information acquisition module to acquire attribute information corresponding to the video data of the broadcast program, the attribute information comprising program information,
wherein the controller transmits the program information in the attribute information to the color gamut information providing device through the communication module, and acquires the color gamut information corresponding to the program information from the color gamut information providing device through the communication module.

3. The image processing device of claim 1,
wherein when the broadcast program of a selected channel is viewed in real time, the controller acquires, before the broadcast program starts, the color gamut information corresponding to the broadcast program from the color gamut information providing device and transmits the acquired color gamut information to the image quality corrector.

4. The image processing device of claim 1, further comprising:
a recording module to record the video data of the broadcast program; and
a recording/reproduction controller to perform control to record the video data in the recording module and to reproduce the video data recorded in the recording module,
wherein when reproducing the video data recorded in the recording module, the controller acquires the color gamut information corresponding to this video data from the color gamut information providing device.

5. The image processing device of claim 4,
wherein each time the video data recorded in the recording module is reproduced, the image quality corrector restores the color gamut of the video data based on the color gamut information.

6. The image processing device of claim 5,
wherein the color gamut information acquired by the controller from the color gamut information providing device when reproducing the video data recorded in the recording module for a first time is used by the image quality corrector when reproducing the video data from a second time or later.

7. The image processing device of claim 1,
wherein the color gamut information provided by the color gamut information providing device is information concerning a color gamut of each of divided sections of the video data of the corresponding program, each divided section being separated by a first separator, and
the image quality corrector restores the color gamut of the video data based on the information concerning the color gamut of each of the divided sections.

8. An image processing method comprising:
acquiring, from a color gamut information providing device color gamut information of video data of a received broadcast program; and
restoring color gamut of the video data of the broadcast program, based on the acquired color gamut information.

9. The image processing method of claim 8, further comprising:
acquiring attribute information corresponding to the video data of the broadcast program, the attribute information comprising program information,
wherein the program information in the attribute information is transmitted to the color gamut information providing device, and the color gamut information corresponding to the program information is acquired from the color gamut information providing device.

10. The image processing method of claim 8,
wherein when the broadcast program of a selected channel is viewed in real time, before the broadcast program starts, the color gamut information corresponding to the broadcast program is acquired from the color gamut information providing device, and the acquired color gamut information is used for restoring the color gamut of the video data of the broadcast program.

11. The image processing method of claim 8, further comprising:
recording the video data of the broadcast program; and
performing control to record the video data in the recording module and to reproduce the video data recorded in the recording module,
wherein when reproducing the recorded video data, the color gamut information corresponding to this video data is acquired from the color gamut information providing device.

12. The image processing method of claim 11,
wherein each time the video data recorded in the recording module is reproduced, the color gamut of the video data based on the color gamut information is restored.

13. The image processing method of claim 12,
wherein the color gamut information acquired from the color gamut information providing device when reproducing the recorded video data for the first time is used when reproducing the video data from a second time or later.

14. The image processing method of claim 8,
wherein the color gamut information provided by the color gamut information providing device is information concerning a color gamut of each of divided sections of the video data of the corresponding program, each divided section being separated by a first separator, and
the color gamut of the video data is restored based on the information concerning the color gamut of each of the divided sections.
